(19) United States
(12) Patent Application Publication
(10) Pub. No.: US 2010/0261473 A1
(43) Pub. Date: Oct. 14, 2010

(54) CELLULAR COMMUNICATION SYSTEM AND A BASE STATION AND METHOD THEREFOR

(75) Inventors: Ban Al-Bakri, Alpes Maritime (FR); Luis Lopes, Swindon (GB)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/714,786

(22) Filed: Mar. 1, 2010

Related U.S. Application Data
(60) Provisional application No. 61/167,680, filed on Apr. 8, 2009.

(51) Int. Cl. H04W 36/00; H04W 92/02

(52) U.S. Cl. 455/435.2; 455/440

(57) ABSTRACT

A cellular communication system comprises a base station which is arranged to support user equipments associated with a plurality of operators or Private Land Mobile Networks (PLMNs). The base station comprises a first unit determining a first operator/PLMN of the plurality of operators/PLMNs serving a first user equipment. A second unit then generates a first message comprising an indication of the first user equipment and an indication of the first operator/PLMN. The first message is transmitted to a management entity of a fixed network of the cellular communication system. The system may allow improved support for equipment sharing in cellular communication networks.

### FIELD OF THE INVENTION

The invention relates to a cellular communication system and a base station and method therefore and in particular, but not exclusively, to equipment sharing in a Long Term Evolution (LTE) cellular communication system.

### BACKGROUND OF THE INVENTION

Cellular communication systems supporting mobile communications have become ubiquitous and in particular second generation cellular communication systems such as the Global System for Mobile Communication (GSM) and 3^{rd} Generation Partnership Project (3GPP) cellular communication systems such as the Universal Mobile Telecommunication System (UMTS) have become widespread.

In order to provide improved communication services and increased efficiency, cellular communication systems are continuously developed and enhanced. For example, currently, the 3GPP standards body is in the process of standardizing improvements to GSM and UMTS known as Long Term Evolution (LTE).

Furthermore, there is a strong desire for new communication standards and enhancements to be implemented while allowing existing functionality to still be used. Accordingly, 3GPP has standardized a network architecture wherein different radio access networks are coupled to a common core network. For example, a 3GPP communication system may comprise both a UMTS Terrestrial Radio Access Network (UTRAN) and a GSM EDGE (Enhanced Data rates for GSM Evolution) Radio Access Network (RAN) coupled to a common core network. In addition, 3GPP is standardizing LTE to allow an LTE based radio access network known as Evolved UTRAN (E-UTRAN) to be coupled to the 3GPP core network.

In contrast to traditional systems, LTE has introduced the concept of allowing different operators or PLMNs (Public Land Mobile Networks) to share equipment. Indeed, LTE allows for such network sharing to be applied even at the base station (also known as an enhanced Node B—eNB in LTE) level such that multiple operators/PLMNs can share the same base station. Thus, LTE allows for air interface sharing of a cell and base station by multiple operators/PLMNs.

However, although LTE allows such network sharing and provides procedures and protocols for supporting e.g. handovers to and from shared base stations, there remains a number of uncertainties, problems and unresolved issues related to network sharing in systems such as LTE. For example, LTE does not define or consider specific charging for shared network scenarios.

Hence, an improved system addressing e.g. such issues would be advantageous.

### SUMMARY OF THE INVENTION

The Invention seeks to preferably mitigate, alleviate or eliminate one or more of the above mentioned disadvantages singly or in any combination.

The invention may provide improved and/or facilitated sharing of base stations in cellular communication systems. For example, the invention may enable and/or improve and/or facilitate differentiated charging.

The inventors have realized that network sharing may be improved and/or facilitated by the base station communicating information to management entities of the fixed segment of the cellular communication system. The inventors have realized that existing operations and protocols are insufficient for many functions and operations in a cellular communication system using shared base stations. For example, the inventors have realized that such network sharing currently considered for LTE will often not allow appropriate charging since the traditionally provided information from the user equipments is insufficient to always allow operator differentiated charging for a shared base station. The inventors have in particular realized that rather than relying on location updates from a user equipment, the base station may provide information allowing improved charging. In particular, the approach may improve or facilitate operator differentiated charging for shared network base stations to be generated by the network.

The fixed network may specifically be a core network. Each operator may correspond to a PLMN. According to a first aspect of the invention there is provided a cellular communication system comprising a base station arranged to support user equipments associated with a plurality of operators, the base station comprising: a first unit for determining a first operator of the plurality of operators serving a first user equipment; a second unit for generating a first message comprising an indication of the first user equipment and an indication of the first operator; and a transmitter for transmitting the first message to a management entity of a fixed network of the cellular communication system.

According to a first aspect of the invention there is provided a method of operation for a cellular communication system comprising a base station arranged to support user equipments associated with a plurality of operators, the method comprising the base station performing the steps of: determining a first operator of the plurality of operators serving a first user equipment; generating a first message comprising an indication of the first user equipment and an indication of the first operator; and transmitting the first message to a management entity of a fixed network of the cellular communication system.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 is an illustration of a cellular communication system in accordance with some embodiments of the invention;

FIG. 2 is an illustration of a base station of a cellular communication system in accordance with some embodiments of the invention; and

FIG. 3 is an illustration of a method of operation for a cellular communication system in accordance with some embodiments of the invention.

### DETAILED DESCRIPTION OF SOME EMBODIMENTS OF THE INVENTION

The following description focuses on embodiments of the invention applicable to a Long Term Evolution (LTE) cellular communication system. However, it will be appreciated that the invention is not limited to this application but may be applied to many other cellular communication systems.

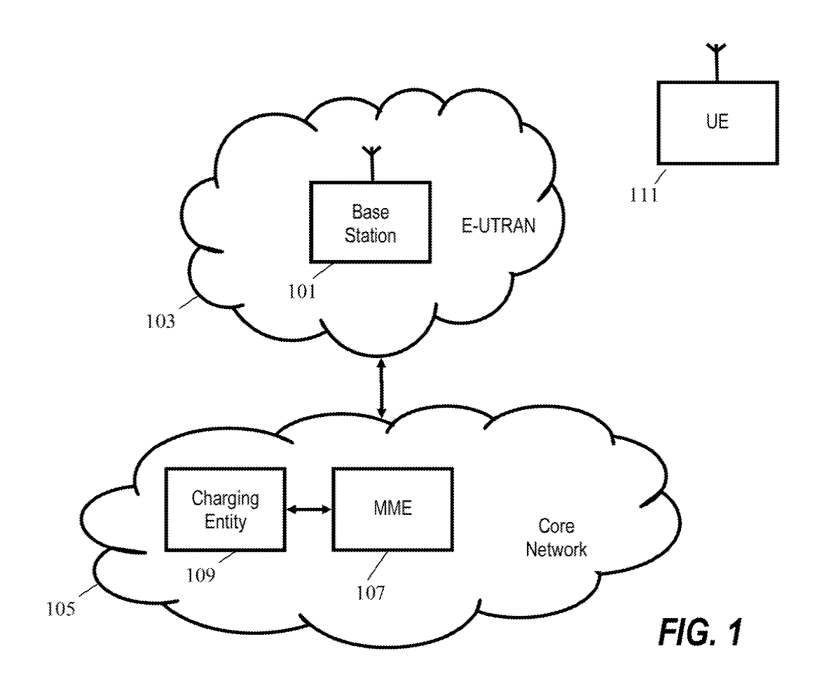

FIG. 1 illustrates an example of some elements of a cellular communication system in accordance with some embodiments of the invention. FIG. 1 illustrates a base station 101 which specifically is an LTE Node B also known as an E-Node B (ENB). The base station 101 is part of an access network 103 which in the specific example is an E-UTRAN (E-Evolved (UMTS (Universal Mobile Telecommunications System) Terrestrial Radio Access Network)) which is coupled to a core network 105. The core network may be an Evolved Packet Core (EPC) network or another core network for a cellular communication system.

As will be known to the skilled person, the access network 103 comprises a number of functional entities including other base stations. Similarly, as will be known to the skilled person, the core network 105 may comprise a large number of different entities including Mobile Management Entities (MMEs), Serving GateWays (S-GW) etc.

FIG. 1 specifically illustrates the core network 105 comprising an MME 107. An MME is the key control-node for the LTE access-network i.e. for the E-UTRAN. It provides a number of functions supporting the mobility of User Equipments (UEs) in LTE access networks. For example, it is responsible for idle mode UE tracking and paging procedure including retransmissions. It is furthermore involved in the bearer activation/deactivation process and is also responsible for choosing an appropriate SGW for the UEs. The MME is further responsible for authentication and authorization. In addition, it maintains routing information for the UEs and also provides control plane functionality for mobility between LTE and 2G/3G access networks.

FIG. 1 furthermore illustrates a charging entity 109 of the core network 105. The charging entity is coupled to the MME 107 and receives resource usage information for the UEs from the MME 107 (as well as other MMEs) and proceeds to generate charging data based on this information. The charging entity may specifically be a MME, PDGW (Packet Data Gateway), PCRF (Policy and Charging Rules Function) or a charging center. LTE makes provision for sharing of equipment between different operators. Indeed, LTE allows for operator sharing of base stations such that the same coverage area can be covered by two operators using the same base station. Such base station sharing may reduce deployment cost, for example in low population density areas.

In the system of FIG. 1, the first base station 101 is shared between a plurality of operators. Specifically, the first base station is shared between networks belonging to different operators. Each operator is associated with a Public Landline Mobile Network (PLMN) and the sharing of the base station 101 between a plurality of operators is equivalent to the sharing of the base station 101 between a plurality of PLMNs (or equivalently to the base station 101 belonging to a plurality of PLMNs). The terms operator and PLMN may be considered equivalent to each other and is used interchangeably in this application.

In cellular systems, each operator is provided with a unique operator identity. For example in 'GPP systems including LTE, an operator or PLMN is given an operator identity which is made up of a number of fields. Specifically, the operator/PLMN identity may be made up of a field providing a Mobile Country Code (MCC) and a field providing a unique Mobile Network Code (MNC) within the country represented by the MCC. Thus, the MNC is used in combination with the MCC (also known as an “MCC/MNC tuple”) to uniquely identify a mobile phone operator/PLMN for cellular communication systems including GSM, CDMA, iDEN, TETRA, UMTS and LTE as well as some satellite mobile networks. Thus, the sharing of the base station 101 by a plurality of operators corresponds to the base station supporting a plurality of unique PLMN identities and specifically a plurality of MCC/MNC identities.

However, whereas such an approach may be advantageous in many scenarios, the Inventors have realized that current approaches and standardization does not consider the complications introduced thereby. Specifically, the Inventors have realized that some network functions, such as charging, may be substantially impaired by the current approach unless specific additional operations and functionality are introduced. As a specific example, the LTE standards allow for intra-base station handovers between different operators/PLMNs. However, such intra-base station inter-PLMN/operator handovers may not be reported to the network thereby preventing the network from generating an accurate and differentiated charging for the individual operators.

The mobility and handover functionality in the core network is based on UE originated information. Specifically, in LTE the system is divided into Tracking Areas (TAs) with each base station being provided with a number of TAs each one is identified by a TA Identity (TAI). The TAI comprises a field providing a location identity known as the Tracking Area Code (TAC) as well as a field comprising a PLMN identity. Also the eNB will be provided with a list of allowed PLMNs where the UE can select for accessing the E-UTRAN. The tracking of the UE as it moves in the system is then based on the UE initiating a Tracking Area Update (TAU) when performing handovers. However, in order to reduce the number of TAUs, the UE may further be provided with a TA list (e.g. by the current serving MME via the current serving base station) which defines a number of TACs that the UE can move within without needing to perform a TAU.

For a shared base station scenario, multiple PLMNs could share the same base station and thus will support a plurality of TAIs which each may have the same TAC but different PLMN identities. Furthermore, in order to reduce the signaling overload and loading of the base station, the UE will typically be provided with a TA list that includes all TAIs of the base station (the TA list is typically generated and controlled by the MME). Accordingly, an active mode UE can move in the TA list, such as when handing over from one operator to another for the same base station, without performing any TAU, i.e. without informing the MME of the move. However, this will result in the MME not being updated when an intra-base station inter-operator handover occurs. Consequently the MME will not have up to date information of which PLMN/operator is currently serving the UE and therefore the charging functionality of the core network is not able to allocate resource usage and charges to the appropriate PLMN/operator.

In the system of FIG. 1, such problems are overcome by not exclusively relying on UE originated TAUs. Rather, in the system of FIG. 1, the base station 101 is equipped to determine information of the serving operator/PLMN for a given UE and to report this to the core network 105. For example, whenever an intra base station inter-operator handover occurs, the base station 101 can generate a message indicating the new operator and transmit this message to the MME 107. The MME 107 may then forward the message (or information) to the charging entity 109 thereby allowing it to determine the charging to be appropriate for the actual operator currently serving the UE.

Specifically, in the system, the base station 101 may keep track of the serving PLMN/operator information and forward this information to the MME over the interface shared between them (namely S1-AP for LTE). This information will include an indication of the used PLMN as well as possible the cell, time of use, type of bearers, etc. This information accordingly allows the network to perform the required charging of the used resources of a specific serving PLMN in the cell.

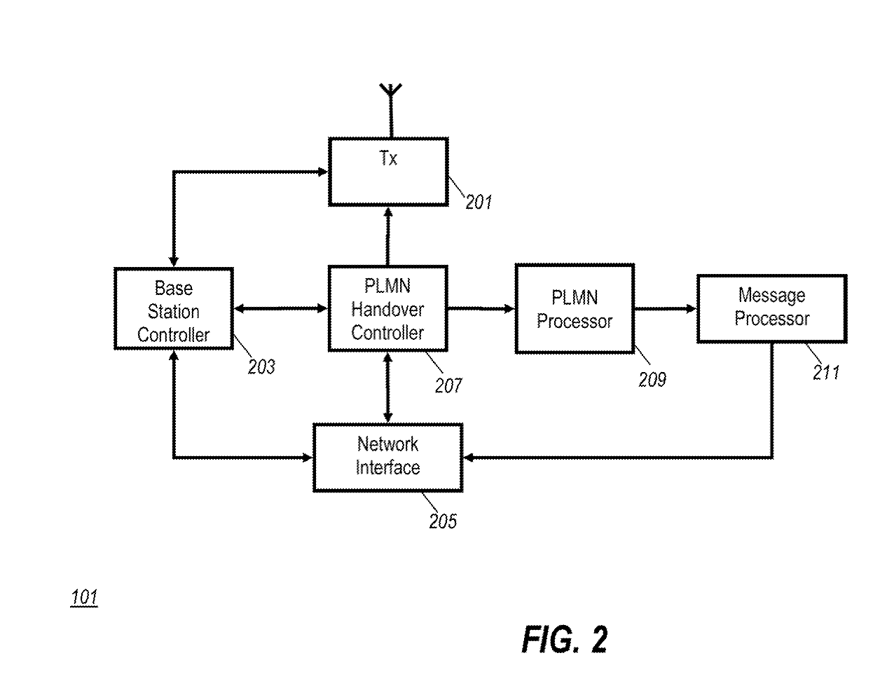

FIG. 2 shows elements of the base station 101 in more detail. The base station 101 comprises a transceiver 201 which is arranged to transmit and receive air interface signals in accordance with the LTE specifications. Specifically, the transceiver 201 can transmit or broadcast the required signals to support multi-operator sharing of the base station 101. The transceiver 201 is coupled to a base station controller 203 which is further coupled to a network interface 205. The network interface 205 comprises functionality for transmitting messages to and receiving messages from other parts of the fixed segment/network (the fixed network comprising the access network 103 and the core network 105). Specifically, the network interface 205 is arranged to exchange messages with the MME 107.

The base station controller 203 is arranged to control the operation of the base station 101 to perform the required or desired functions of the base station 101 in accordance with the LTE standards. In particular, the base station controller 203 may provide the required operations and functions for supporting a plurality of operators/PLMNs. The base station controller 203 is coupled to a PLMN handover controller 207 which is arranged to support handover of a UE 111 from one operator/PLMN to another. The PLMN handover controller 207 can specifically execute the procedures required for an intra-base station inter-PLMN handover for the UE 111 including exchanging the required signaling with the UE 111.

The PLMN handover controller 207 is coupled to a PLMN processor 209 which is arranged to determine the operator that is associated with each UE and in particular which operator/PLMN is associated with the UE 111. Thus, the PLMN processor 209 may keep track of which operator/PLMN is the current serving operator/PLMN. The PLMN processor 209 may determine this both for UEs that are in idle mode as well as for active UEs (specifically in connected mode). The PLMN processor 209 is coupled to a message processor 211 which can receive information from the PLMN processor 209 indicating the current supporting/serving operator/PLMN for the UEs. The message processor 211 can then generate messages that comprise information of the operator/PLMN supporting a given UE. Specifically, the message processor 211 can generate a message for the UE 111 which indicates which PLMN it is currently served by. The message comprises an indication of the UE 111 and of the currently serving operator/PLMN.

The message processor 211 is further coupled to the network interface 205. The message processor 211 forwards the messages to the network interface 205 from which they are transmitted to the MME 107. Specifically, the messages are transmitted from the base station 101 to the MME 107 using the S1-AP interface. In the example of FIG. 1, the base station 101 is arranged to generate a new message when the PLMN handover controller 207 detects that an intra-base station inter-PLMN handover has taken place. In the example, the UE 111 is provided with a TA list that includes the TAI of all the PLMNs that share the base station 101. The UE 111 may accordingly hand over from a first PLMN to a second PLMN sharing the base station 101. However, as both the associated TAIs are included in the TA list, the UE 111 will not proceed to initiate a TAU.

However, in the example, the PLMN handover controller 207 detects that the operator/PLMN that is serving the UE 111 has changed. Specifically, the PLMN handover controller 207 detects that the UE 111 has handed over to the second PLMN and it feeds this information to the PLMN processor 209. The PLMN processor 209 then proceeds to designate the second PLMN as the current serving PLMN and it forwards this information to the message processor 211. Thus, the message processor 211 is informed of the identity of the PLMN/operator serving the UE 111 following the intra-base station inter-PLMN handover. Accordingly, the PLMN processor 209 may identify the second PLMN as the serving PLMN following the handover. The message processor 211 then proceeds to generate a message comprising the identity of the second PLMN as well as the identity of the UE 111 (implicitly or explicitly). The message is then transmitted to the MME 107.

In the example, the base station 101 detects PLMN handovers and generates a PLMN update message which is transmitted to the MME whenever such a handover occurs. Thus, although the UE 111 does not initiate any TA update process, the core network 105 is still informed of the change of the serving PLMN. Accordingly, the core network 105 may proceed to adjust the charging to reflect the changed serving PLMN. In the specific example, the MME 107 may generate an update message which is transmitted to the charging entity 109 informing it that the PLMN has changed. The charging entity 109 will typically already have information of the service being provided to the UE 111 (such as e.g. Quality of Service levels etc). Accordingly, it may proceed to generate the charging based on existing information while modifying it to reflect that a different PLMN/operator is now serving the UE 111. As a simple example, the charging entity may simply proceed with the same nominal charging but change the recipient from being the first PLMN/operator to being the second PLMN/operator. As another example, the charging entity may proceed to generate an unchanged home operator charge to the subscriber of the UE 111 while generating a second charge from the second PLMN/operator to the subscriber's home operator.

The message reporting the change of PLMNs may specifically be a location update message used in the system for reporting handover location updates. Thus, the same message type/format may be used for both handover location updates originating from a TAU and for reporting a changed PLMN following an intra-base station inter-PLMN handover. In the specific example, the message is a LOCATION REPORT message of the LTE system. Thus, in the system, the LOCATION REPORT message of 'GPP Technical Specification 36.413 is transmitted to the MME 107 by the base station 101 whenever a intra-base station inter-PLMN handover occurs. This message includes an identification of the user equipment making the handover as well as an indication of the PLMN to which it is handing over. The indication may specifically be an identification in the form of a TAI.

In the example, the message transmitted to the MME 107 may further comprise an indication of the duration in which the UE 111 has been served by the second PLMN/operator. Thus, the PLMN processor 209 may also measure the time that has passed since the handover was completed until the message is transmitted and indicate this duration in the update message. Furthermore, the duration reported in the message is bounded by an upper value. Thus, if the duration exceeds a given threshold then this threshold value is reported instead of the actual value.

In the specific example, the LOCATION REPORT message is modified to include an indication of the duration in which the UE 111 has been served by the PLMN reported in the message. This value is provided in seconds using a number of fixed values. Specifically, the system of FIG. 1 uses a modified version of the LOCATION REPORT message of section 8.11.3 of TS 36.413 as given in the following table:

| | | | IE type | | | |
|---|---|---|---|---|---|---|
| | | | and | Semantics | | Assigned |
| IE/Group Name | Presence | Range | reference | description | Criticality | Criticality |
| Message Type | M | | 9.2.1.1 | | YES | ignore |
| MME UE S1AP | M | | 9.2.3.3 | | YES | reject |
| ID | | | | | | |
| eNB UE S1AP ID | M | | 9.2.3.4 | | YES | reject |
| E-UTRAN CGI | M | | 9.2.1.38 | | YES | ignore |
| TAI | M | | 9.2.3.16 | | YES | ignore |
| > Time UE stayed | O | | TBD | The | | |
| in a PLMN | | | | duration of | | |
| | | | | the time | | |
| | | | | the UE | | |
| | | | | stayed in | | |
| | | | | the PLMN | | |
| | | | | in seconds. | | |
| | | | | ENUMER | | |
| | | | | ATED(1 s, | | |
| | | | | 2 s, 5 s, 10 s, | | |
| | | | | 20 s, | | |
| | | | | 60 s, . . . etc) | | |
| | | | | To be used | | |
| | | | | for | | |
| | | | | charging | | |
| | | | | purposes | | |
| Request Type | M | | 9.2.1.34 | | YES | ignore |

The information of the duration in which the UE 111 has been served by the new second PLMN may then be used by the charging entity to amend the charging from the appropriate time interval despite any delays in reporting the handover.

In some embodiments, the update message transmitted to the MME 107 may further include resource usage data for the UE 111 in the update message. Thus, the update message may comprise information indicative of the resource that is being used such as a radio bearer used by the UE 111, the Quality of Service provided etc. This may assist and/or improve charging. For example, it is possible that the intra base station inter-PLMN handover may result in a change of the QoS parameters and in some embodiments this may be detected by the base station 101 and reported to the MME 107 in the data message.

It will also be appreciated that in some embodiments, the update message may not be transmitted to the MME 107 but rather to another entity of the core network 105 or even the access network 103. For example, the update message may be transmitted directly to the charging entity 109.

Thus, the described system provides a method in LTE for providing charging information related to the resources used by a user equipment of any PLMN used on the radio interface while roaming and moving without the UE having to update the core network with the information. This is achieved by the base station collecting the required information and providing this information to the serving core network/MME over the common interface S1-AP. In some embodiments, the system furthermore allows for the reporting of the PLMN information to be controlled remotely. Specifically, the network interface 205 may receive a reporting control message from the MME 107 comprising an indication of a serving operator reporting characteristic. The base station 101 then proceeds to adapt the reporting operation to provide the reporting characteristic specified in the reporting message.

In the specific example, the reporting message may indicate whether changes of PLMNs should be reported or not. In the example, the base station 101 is arranged to operate in a reporting or non-reporting mode of operation. In the reporting mode, the base station 101 generates and transmits an indication of the new serving operator/PLMN for a user equipment whenever it is detected that a change of serving operator has occurred for user equipment. However, in the non-reporting mode, the base station 101 does not instigate the transmission of an indication of the new operator/PLMN when a new serving operator/PLMN is detected for the user equipment.

Thus, in the specific example, the base station 101 may operate in a reporting mode wherein an update message comprising an indication of the new operator/PLMN is generated and transmitted to the network when an intra-base station inter-PLMN handover is detected for a user equipment. Alternatively, the base station 101 may operate in a non-reporting mode wherein such an indication (and specifically no such message) is transmitted when an intra-base station inter-PLMN handover is detected. The base station is furthermore arranged to switch between the two modes in response to a reporting message received from the network 103, 105 and specifically from the MME 107. Thus, in such embodiments, the network may control whether PLMN changes that are otherwise not reported (since no TAU is initiated) should be reported or not by the base station. This may provide a more flexible and efficient approach and may reduce signalling overhead in many scenarios.

In the specific example of an LTE system, the reporting control message is specifically the LOCATION REPORTING CONTROL message (section 8.11.1 of TS 36.413). In the example, the MME 107 initiates the reporting procedure by sending a LOCATION REPORTING CONTROL message. On receipt of a LOCATION REPORTING CONTROL message the base station 101 performs the requested location reporting control action for the user equipment. In the example, the operator reporting indication is comprised in the Request Type Information Element (IE) of the LOCATION REPORTING CONTROL message. Specifically, the Request Type IE indicates to the base station (eNB) whether:
to report directly;
to report upon change of serving cell, or
to stop reporting at change of serving cell,
in case of network sharing in EUTRAN;
   to report upon change of serving cell and PLMN, or
   to stop reporting at change of serving cell and PLMN.

If reporting upon change of serving cell and/or change of cell and PLMN is requested, the base station 101 reports whenever the user equipment changes its serving cell to another cell belonging to the base station 101. The base station 101 keeps track of the time the user equipment spends on each PLMN. The Request Type IE also indicates what type of location information the base station shall report. The location information is E-UTRAN CGI (Cell Global Identity) and TAI.

The request type IE may specifically comprise the following information:

| | | | | |
|---|---|---|---|---|
| IE/ | | | | |
| Group | | | | Semantics |
| Name | Presence | Range | IE Type and Reference | Description |

| | | |
|---|---|---|
| Request | | |
| Type | | |
| Event | M | ENUMERATED(Direct, |
| | | Change of service cell, Stop |
| | | Change of service cell, |
| | | change of serving cell and |
| | | PLMN, Stop change of |
| | | servicing cell and PLMN) |
| Report | M | E-UTRAN CGI |
| Area | | |

Optionally, in some embodiments the request type may also indicate the need for the report to include the time the UE stayed in a cell or PLMN.

In some embodiments, the base stations of the access network 103 may further be arranged to exchange information with each other relating to a previous server operator/PLMN. Specifically, when a source base station hands over to a target base station, the source base station may also forward information to the target base station informing it of which operator/PLMN served the user equipment prior to the handover. This information may also include information of a duration in which the previous operator/PLMN served the user equipment. For example, the UE 111 may hand over from a source base station (not shown) to the base station 101 which accordingly is a target base station for the handover. As part of this handover process, the network interface 205 of the target base station 101 may receive a message from the source base station which comprises an indication of the serving operator for the UE 111 prior to the handover. This message may be received by the network interface 205 on the 51 interface and can specifically include an identity of the operator/PLMN that served the UE 111 at the source base station 101 when the handover was initiated/performed. This previous operator/PLMN may be the same or different than the operator/PLMN that serves the UE 111 following the handover.

The message is forwarded to the PLMN handover controller 207 which also controls the inter-base station handover. The PLMN handover controller 207 forwards the message to the PLMN processor 209 which is arranged to control the message processor 211 to forward the information of the previous serving operator/PLMN to the MME 107. The data may, for example, be forwarded in a location reporting message that is also used to report intra-base station inter-PMLN handovers or may be transmitted in a different message. In some embodiments, the appropriate information element of the inter-base station message may simply be forwarded unamended to the MME 107.

Similarly, if the UE 111 hands over from the base station 101 to a new target base station (thus making the base station 101 the source base station), the PLMN handover controller 207 may execute the handover and as part of this process may provide an indication of the handover to the PLMN processor 209. In response, the PLMN processor 209 determines which operator/PLMN is serving the UE 111 at the initiation of the handover as well as how long this operator/PLMN has served the UE 111. This information is fed to the message processor 211 which accordingly proceeds to include the information in a message which is transmitted to the target base station via e.g. the X2 inter base station interface (not shown). The target base station may then forward the information to the MME 107.

The inter-base station message may specifically be generated if the PLMN processor 209 detects that information of a change of serving operator/PLMN has not yet been forwarded to the MME 107. Thus, when a handover to another base station occurs, the information of the serving operator/PLMN may be passed to the new base station in case the information has not yet been passed to the core network/MME. This may in some embodiments be in addition to a message being transmitted directly to the MME 107 by the source base station. The use of such an inter-base station message may provide increased reliability in many scenarios and may reduce the risk that information of a change of operator/PLMN is lost due to the handover.

The information of the serving operator/PLMN may specifically be provided in a handover request message transmitted between the base stations. In the example of an LTE system, the message may be a HANDOVER REQUEST message sent by the source base station to the target base station to request the preparation of resources for a handover. This message may specifically comprise the following information:

| | | | IE type and | Semantics | | Assigned |
|---|---|---|---|---|---|---|
| IE/Group Name | Presence | Range | reference | description | Criticality | Criticality |
| Message Type | M | | 9.2.13 | | YES | reject |
| Old eNB UE X2AP | M | | eNB UE | Allocated at the | YES | reject |
| ID | | | X2AP ID | source eNB | | |
| | | | 9.2.24 | | | |
| Cause | M | | 9.2.6 | | YES | ignore |
| Target Cell ID | M | | ECGI | | YES | reject |
| | | | 9.2.14 | | | |
| GUMMEI | M | | 9.2.16 | | YES | reject |
| UE Context | | 1 | | | YES | reject |
| Information | | | | | | |
| > MME UE S1AP | M | | INTEGER | MME UE S1AP ID | — | — |
| ID | | | (0 . . . 2³²−1) | allocated at the | | |
| | | | | MME | | |
| > UE Security | M | | 9.2.29 | | — | — |
| Capabilities | | | | | | |
| >AS Security | M | | 9.2.30 | | — | — |
| Information | | | | | | |
| > UE Aggregate | M | | 9.2.12 | | — | — |
| Maximum Bit | | | | | | |
| Rate | | | | | | |
| > Subscriber | O | | 9.2.25 | | — | — |
| Profile ID for | | | | | | |
| RAT/Frequency | | | | | | |
| priority | | | | | | |
| >E-RABs To Be | | 1 | | | — | — |
| Setup List | | | | | | |
| >>E-RABs To | | 1 to | | | EACH | ignore |
| Be Setup Item | | <max | | | | |
| | | noof | | | | |
| | | Bearers> | | | | |
| >>> E-RAB | M | | 9.2.23 | | — | — |
| ID | | | | | | |
| >>> E-RAB | M | | 9.2.9 | Inlcudes necessary | — | — |
| Level QoS | | | | QoS parameters | | |
| Parameters | | | | | | |
| >>> DL | O | | 9.2.5 | | — | — |
| Forwarding | | | | | | |
| >>> UL GTP | M | | GTP Tunnel | SGW endpoint of | — | — |
| Tunnel | | | Endpoint | the S1 transport | | |
| Endpoint | | | 9.2.1 | bearer. For delivery | | |
| | | | | of UL PDUs | | |
| > RRC Context | M | | OCTET | to transfer UE | — | — |
| | | | STRING | RAN context, see | | |
| | | | | subclause 10.2.3 in | | |
| | | | | [9]. | | |
| >Handover | O | | 9.2.3 | | — | — |
| Restriction List | | | | | | |
| >Location | O | | 9.2.21 | Includes the | — | — |
| Reporting | | | | necessary | | |
| Information | | | | parameters for | | |
| | | | | location reporting | | |
| UE History | M | | OCTET | Defined in [4] | YES | ignore |
| Information | | | STRING | | | |
| Trace Activation | O | | 9.2.2 | | YES | ignore |
| SRVCC Operation | O | | 9.2.33 | | YES | ignore |
| Possible | | | | | | |

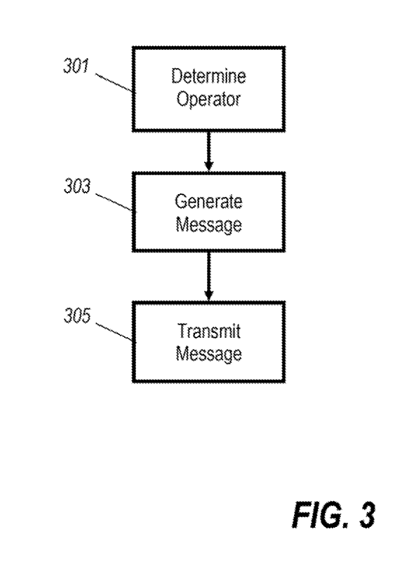

FIG. 3 illustrates an example of a method of operation for a cellular communication system comprising a base station arranged to support user equipments associated with a plurality of operators. The method initiates in step 301 wherein a first operator of the plurality of operators serving a first user equipment is determined. Step 301 is followed by step 303 wherein a first message comprising an indication of the first user equipment and an indication of the first operator is generated. Step 303 is followed by step 305 wherein the first message is transmitted to a management entity of a fixed network of the cellular communication system.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims does not imply any specific order in which the features must be worked and in particular the order of individual steps in a method claim does not imply that the steps must be performed in this order. Rather, the steps may be performed in any suitable order.

1. A base station for a cellular communication system, the base station being arranged to support user equipments associated with a plurality of operators and comprising:
a first unit for determining a first operator of the plurality of operators serving a first user equipment;
a second unit for generating a first message comprising an indication of the first user equipment and an indication of the first operator; and
a transmitter for transmitting the first message to a management entity of a fixed network of the cellular communication system.

2. The base station of claim 1 arranged to transmit the first message in response to a detection of a change of a serving operator for the first user equipment.

3. The base station of claim 2 wherein the second unit is arranged to determine the first operator as an operator serving the first user equipment following the change of the serving operator.

4. The base station of claim 1 wherein the first message is a location update message capable of reporting serving cell changes due to handover.

5. The base station of claim 1 wherein the first message is a LOCATION REPORT message of a Long Term Evolution cellular communication system.

6. The base station of claim 1 wherein the second unit is arranged to determine a duration in which the first user equipment has been served by the first operator and to include an indication of the duration in the first message.

7. The base station of claim 6 wherein the second unit is arranged to set the indication to be indicative of a maximum value if the duration exceeds the maximum value.

8. The base station of claim 1 further comprising:
a receiver for receiving a reporting control message from the management entity, the reporting control message comprising a serving operator reporting indication; and
a reporting control unit for modifying a serving operator reporting characteristic for the base station in response to the serving operator reporting indication.

9. The base station of claim 8 wherein the reporting control unit is arranged to switch the base station to a non-reporting mode of operation in response to the serving operator reporting indication being indicative of a requirement for operator changes not to be reported, the non-reporting mode comprising the base station not transmitting an indication of a new serving operator for the first user equipment when a change of serving operator occurs for the first user equipment.

10. The base station of claim 8 wherein the reporting control unit is arranged to switch the base station to a reporting mode of operation in response to the serving operator reporting indication being indicative of a requirement for operator changes to be reported, the reporting mode comprising the base station transmitting an indication of a new serving operator for the first user equipment in response to a detection of a change of serving operator for the first user equipment.

11. The base station of claim 8 wherein the reporting control message is a LOCATION REPORTING CONTROL message of a Long Term Evolution cellular communication system.

12. The base station of claim 11 wherein the operator reporting indication is comprised in a Request Type Information Element of the LOCATION REPORTING CONTROL message.

13. The base station of claim 1 wherein the first user equipment has a tracking area list comprising tracking area identifications for at least two of the plurality of operators.

14. The base station of claim 1 further comprising a handover unit for supporting a handover of the first user equipment to a target base station, the handover unit being arranged to transmit a second message to the target base station, the second message comprising an indication of the first operator.

16. The base station of claim 1 further comprising a handover unit for supporting a handover of the first user equipment from a source base station, the handover unit being arranged to receive a second message from the source base station, the second message comprising an indication of a serving operator for the first user equipment when served by the source base station; and wherein the transmitter is arranged to transmit a third message comprising an indication of the serving operator to the management entity.

17. The base station of claim 1 wherein the management entity is a Mobile Management Entity, MME.

18. The base station of claim 1 wherein the generating unit is arranged to include resource usage data for the first user equipment in the first message.

19. A cellular communication system comprising a base station arranged to support user equipments associated with a plurality of operators, the base station comprising:
a first unit for determining a first operator of the plurality of operators serving a first user equipment;
a second unit for generating a first message comprising an indication of the first user equipment and an indication of the first operator; and
a transmitter for transmitting the first message to a management entity of a fixed network of the cellular communication system.

20. A method of operation for a cellular communication system comprising a base station arranged to support user equipments associated with a plurality of operators, the method comprising the base station performing the steps of:
determining a first operator of the plurality of operators serving a first user equipment;
generating a first message comprising an indication of the first user equipment and an indication of the first operator; and
transmitting the first message to a management entity of a fixed network of the cellular communication system.
